(19) United States
(12) Patent Application Publication
(10) Pub. No.: US 2010/0227682 A1
(43) Pub. Date: Sep. 9, 2010

(54) AWARDING OF AVATAR ITEMS IN VIDEO GAME ENVIRONMENT

(75) Inventors: Brendan Reville, Seattle, WA (US); Derek H. Smith, Snohomish, WA (US); Stacey Law, Redmond, WA (US); Thomas A. Langan, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/398,020

(22) Filed: Mar. 4, 2009

(51) Int. Cl. A63F 13/00

(52) U.S. Cl. 463/29

(57) ABSTRACT

Embodiments related to the introduction of new avatar items to a video game environment are disclosed. One embodiment provides a computer-readable medium comprising code executable by a computing device to perform a method of presenting a video game to a user. The code comprises code executable to display in the video game an avatar representing the user, code executable to receive input from a user of the video game during game play, code executable to detect an occurrence of a designated event in the video game during game play that results from input received from the user during game play, code executable to award the user access to an avatar item upon the occurrence of the designated event, and code executable to store code representing the appearance of the avatar item in a location external to the video game.

### BACKGROUND

Video game systems sometimes feature two-dimensional or three-dimensional representations of users known as avatars. An avatar may represent a user in a variety of contexts, including computer or video games, applications, chats, forums, communities, and instant messaging services. An avatar can be thought of as an object representing the embodiment of a user, and may represent various personal characteristics, qualities, interests, etc. of the user.

Some avatar use environments may enable the customization of the appearance of an avatar in various ways. For example, in some video game systems, a user may customize facial features, hair style, skin tone, body build, clothing, and/or accessories of an avatar. However, many such systems have a pre-defined set of clothing and accessory options, collectively referred to herein as “avatar items.” In such systems, the set of items that can be added to an avatar is limited to those items that are defined when the video gaming system was manufactured.

Other avatar use environments may allow the introduction of new game-specific avatar items. However, such functionality may be limited to a single game, and a user may not be able to use such items outside the context of the game.

### SUMMARY

Accordingly, various embodiments related to the introduction of new avatar items to a video game environment are disclosed. For example, one embodiment provides a computer-readable medium comprising code stored thereon that is executable by a processor on a computing device to perform a method of presenting a video game to a user. The code comprises code executable to display in the video game an avatar representing the user, code executable to receive input from a user of the video game during game play, code executable to detect an occurrence of a designated event in the video game during game play that results from input received from the user, code executable to award the user access to an avatar item upon the occurrence of the designated event, and code executable to store code representing the appearance of the avatar item in a location external to the video game.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an embodiment of a video game environment.

FIG. 2 is a block diagram of an embodiment of an extensible avatar system for use in a video game environment.

FIG. 3 is a flow diagram depicting an embodiment of a method of awarding an avatar item in a video game.

FIG. 4 is a flow diagram depicting another embodiment of a method of awarding an avatar item in a video game.

FIG. 5 is a flow diagram depicting a method of incorporating an avatar item award into a video game.

### DETAILED DESCRIPTION

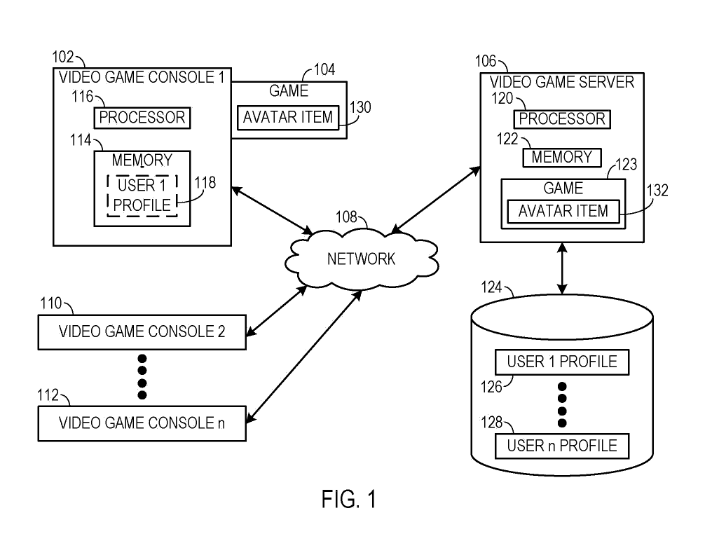

Before discussing the introduction of new avatar items in a video game environment, an example of a suitable use environment is described with reference to FIG. 1, which shows an example embodiment of a video game environment 100. Video game environment 100 comprises a first video game console 102 with a video game storage medium 104 inserted therein. The video game storage medium 104 may comprise any suitable type of storage, including but not limited to a digital versatile disk (DVD), a flash memory cartridge, etc. The video game console 102 is also connected to a video game server 106 via a network 108. In this manner, a player using the video game console 102 may play games accessed from the video game medium 104, from the video game server 106, and/or from a combination of both the video game medium 104 and video game server 106.

Further, other video game consoles may be connected to the video game server 106 via network 108, as illustrated by video game console 2 110 and video game console n 112 in FIG. 1. This allows players using different video game consoles at different physical locations to play multi-player games over the network 108. It will be understood that the network 108 may represent any suitable network or combinations of networks, including but not limited to public and/or private local area networks, and/or public and/or private wide area networks, including but not limited to the Internet.

Video game console 102 comprises memory 114 and a processor 1 16. The memory 114 may comprise computer-readable instructions, for example, in the form of computer programs, stored thereon that are executable by the processor 104 to implement a video game environment. Such instructions may be executable, for example, to present a video game via instructions read from video game medium 104, to communicate with the video game server 106 over the network 108, and/or perform any other suitable operations related to the presentation of a video game to a player.

Further, the instructions stored on memory 114 also may be configured to implement an avatar system, an example embodiment of which is described in more detail below. In brief, such an avatar system may be configured to allow a user to design a personalized avatar, accessorize the avatar with various avatar items, and then use the avatar as a personal representation in video games and other video entertainment activities. As such, the memory 114 on the video game console 102 may comprise one or more user profiles 118 stored thereon, wherein the user profiles may store avatar information for each player, as described in more detail below.

The video game server 106 likewise comprises a processor 120, and memory 122 that comprises instructions executable by the processor to present a video game 123 to players at video game consoles 102, 110 and 112 over network 108. The video game server 106 may further comprise, or be in communication with, storage 124, such as a database, that contains copies of profiles for a plurality of players who access the video game server 106. As shown in FIG. 1, a copy of the user profile stored on video game console 102 is also stored in storage 124 (as shown at 126), along with a number of other user profiles, up to user profile n 128. While only one video game 123 is shown being presented on video game server 106 for the purpose of clarity, it will be understood that any suitable number of video games may be presented via a video game server 106 at any time, and that such games may be stored in a database or the like (not shown) accessible by the video game server 106.

Further, an avatar item 130 may be contained within the video game stored on the video game medium 104 such that a player may obtain the avatar item 130 by playing the video game stored on video game medium 104. Likewise, an avatar item 132 may be contained within the video game 123 stored on video game server such that a user may obtain the avatar item 132 by playing the video game 123 presented by the video game server 106. The award of avatar items in a video game is discussed in more detail below.

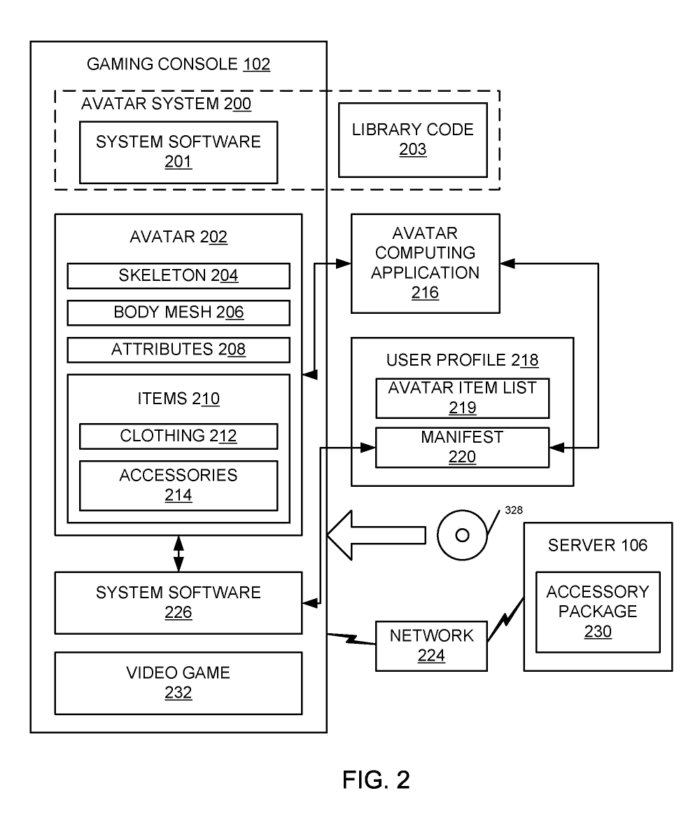

FIG. 2 shows an avatar system 200 that may be implemented via instructions executed on video game console 102. The avatar system 200 may be implemented as system software 201, library code 203 available to publishers of video games and other content providers, or as a combination of system software 201 and library code 203, as illustrated by the dashed box in FIG. 2. The avatar system 200 generates an avatar 202 that represents a user in any of a variety of contexts, including, for example, video games, chat or instant messaging applications, forums, communities, and the XBOX LIVE® service.

The avatar system 200 may generate or maintain a three-dimensional “skeleton” 204, a deformable body mesh 206, a set of attributes 208 specifying the appearance of the face and/or body of the avatar 202, and a basic set of avatar items 210, such as clothing 212 and accessories 214. This information may be stored in system software. In addition, video game disks may store packages of assets that define further options for any of these characteristics.

The skeleton 204 may comprise a standardized skeleton that allows avatar computing applications 216, such as video game applications that are designed to incorporate avatars in the context of the game, to move parts of the skeleton 204 at well-defined pivot points. Such avatar computing applications 216 can animate any avatar with knowledge of the standardized skeleton and without any other specific knowledge about the appearance of the avatar.

In addition to the skeleton, the avatar system 200 may generate or maintain a body mesh 206 that defines the form of the avatar 202, e.g., the height of the avatar 202 and whether the avatar 202 is of a slim, average, or muscular build. The avatar system 200 may also generate or maintain a set of attributes 208 relating to the appearance of the face or body, or both, of the avatar 202. For example, the avatar system 200 may maintain a set of attributes that describe certain aspects of the avatar's face, such as eye color, hair style, coloration, etc.

In some embodiments, the avatar system 200 generates or maintains a basic set of avatar items 210, such as clothing 212 and accessories 214, that can be applied to the avatar 202. For example, the avatar 202 may have handbags, sunglasses, hats, jewelry, and the like. Some avatar items 210 may be applied to the avatar 202, such that the avatar computing application 216 displays the avatar 202 as wearing or using the avatar items 210. Other avatar items 210 may be possessed by the avatar 202, but not applied to the avatar 202. For example, the avatar 202 may possess several different pairs of sunglasses, but can wear one pair at a time. In other words, the avatar 202 can only have one pair of sunglasses applied at any given time. Avatar items 210 that are possessed by, but not currently applied to, the avatar 202 can be applied to the avatar 202 at a later time. The user profile (user profiles 118, 126 and 128 are represented generically in FIG. 2 as user profile 218) can store a data structure, referred to herein as an avatar item list 219, that identifies which avatar items 210 are possessed by the avatar 202. The user profile 218 also may store another data structure, which may be referred to as an avatar manifest 220 that identifies which avatar items are currently applied to the avatar 202. It will be understood that, in other embodiments, both types of information (possessed avatar items and applied avatar items) may be stored in a single data structure.

The avatar item list 219 and manifest 220 each may comprise a number of fields, including, for example, a field identifying a type of an item (e.g., shirt, glasses, etc.), an item identifier comprising a name of the item, and a location identifier that denotes where on the body of the avatar 202 the item is applied. Further, in embodiments where both types of information are stored in a single data structure, the data structure may further comprise a flag indicating whether the item is currently applied to the avatar 202. An existing media identifier scheme, e.g., the media identifier scheme used by the XBOX LIVE® service, may be used to represent items. In this way, the avatar system is extensible because items conform to a standardized identification scheme. The avatar items 210 themselves, i.e., graphical representations of the avatar items 210, can be stored either locally on the video game console 102, and/or remotely on server 106 connected to the video game console 102 via network 108.

The instructions stored on the video game console 102 also may include a closet application 226 that, among other functions, allows the user to apply avatar items 210 to the avatar 202. The closet application 226 may allow the user to “try on” an avatar item 210 on his or her avatar 202 by temporarily applying the avatar item 210 to the avatar 202.

In addition, according to an aspect of this disclosure, the closet application 226 allows the user to customize the avatar 202 by acquiring new avatar items 210. Unlike some conventional avatar systems in which the set of items that can be applied to an avatar is determined when the game console is manufactured, the avatar system 200 disclosed herein is extensible. In particular, the avatar system 200 allows the user to acquire and apply avatar items 210 that are defined after the game console 102 is manufactured.

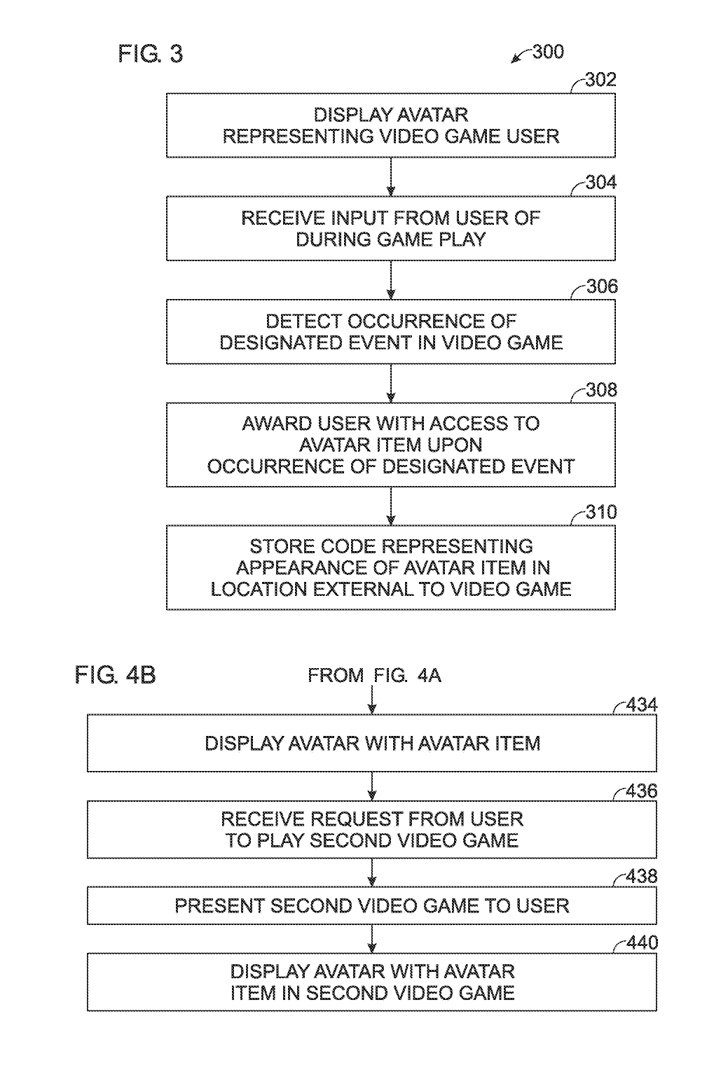

FIG. 3 shows an embodiment of a method 300 of introducing a new avatar item into avatar system 200. Method 300 allows a user to win access to an avatar item 210 by reaching a goal, or performing any other suitable designated action, during computer or video game play. Further, upon winning access to the avatar item 210, the user may apply the avatar item 210 to the avatar 202 for use in other environments than the video game in which the avatar item 210 was awarded, including but not limited to applications, chats, forums, communities, and instant messaging services. The term “video game” as used herein may apply to any computer or video game played on any suitable computing device, whether single-player or multi-player, console-based, computer-based, network-based, etc.

Method 300 first comprises, at 302, displaying in a video game an avatar representing a video game user, and then, at 304, receiving input from the user of the video game during game play. Such input may be any suitable input in any suitable video game environment. For example, the input may come from a hand-held controller, keyboard, joystick, motion sensor, image sensor, or any other input device with which the user may interact with the game.

Next, at 306, method 300 comprises detecting an occurrence of a designated event in the video game, where the occurrence of the designated event results from input received from the player during game play. Occurrence of the designated event serves as a trigger for the awarding of access to an avatar item that can be obtained in the video game. As such, the designated event may be any suitable event in the video game. For example, where a game is a scored game, access to the avatar item may be awarded upon reaching a designated game score. Likewise, where a game is an unscored game (such as an adventure game), access to the avatar item may be awarded by meeting specified challenges in the game. As a more specific example, an avatar item may be awarded upon completing a game, upon completing a level in a game, upon defeating a specific character in a game, or in any other suitable Thus, the avatar item may indicate to other users the status and/or level a user has reached in a game. In yet other embodiments, a user may acquire an avatar item from a “shop” in the video game environment upon acquiring a sufficient amount of a currency used in the video game environment. In these embodiments, the designated event comprises the purchase of the item in exchange for previously earned currency. It will be understood that these specific embodiments are described for the purpose of example, and are not intended to be limiting in any manner.

Continuing with FIG. 3, upon detecting the occurrence of the designated event in the video game, method 300 next comprises, at 308, awarding the user with access to the avatar item. This may comprise, for example, calling an API on a video game console that updates the user's avatar item list 219 and/or avatar manifest 220 with the awarded avatar item. For example, the user's avatar item list and/or avatar manifest may be updated to show that the user has acquired access to the avatar item, as described above. Further, upon being awarded access to the avatar item, the user may be presented with the choice of whether to apply the avatar item to the user's avatar. If the user elects to apply the avatar item to the user's avatar, the user's avatar item list and/or avatar manifest may further be modified to indicate that the newly acquired avatar item is currently applied to the avatar.

Upon awarding the avatar item to user upon occurrence of the designated event, method 300 comprises, at 310, storing code representing an appearance of the avatar item in a location external to the video game. The term “external to the video game” as used herein refers to a location where the code representing the appearance of the avatar item can be accessed for application to the avatar even when the video game from which the avatar item was obtained is no longer inserted in or otherwise directly available to the console. For example, code representing the appearance of the avatar item may be stored locally on a game console, and/or remotely on a user profile on a video game server or other remote computer. Storing the code in a location external to the video game allows the user to apply the avatar item to the user's avatar when playing other video games that utilize the user's avatar. For example, if the user is playing a video game via an optical disk inserted into a video game console, an avatar item won during the game may be stored locally on the video game console. Then, if the user removes the disk and then inserts a second disk to play a different game, the avatar item will still be available to the user, even if a copy is not located on the second disk.

Further, if the user is connected to a remote computer, such as a video game server, via a network link or the like, the user's updated avatar item list 219 and avatar manifest 220 may be synchronized with a copy of the user's manifest stored on the remote computer. Then, if the user logs onto a game from a different console also connected to the remote computer via a network link, that console may access the manifest, and then acquire the avatar item from a copy of the video game stored on the remote computer. Further, other users who are interacting with the user in a multi-player activity may see the avatar item by obtaining a copy of the avatar item over the network connection. It will be understood that such other users may be restricted from using the avatar item on their avatars unless they have themselves been awarded the avatar item for game play.

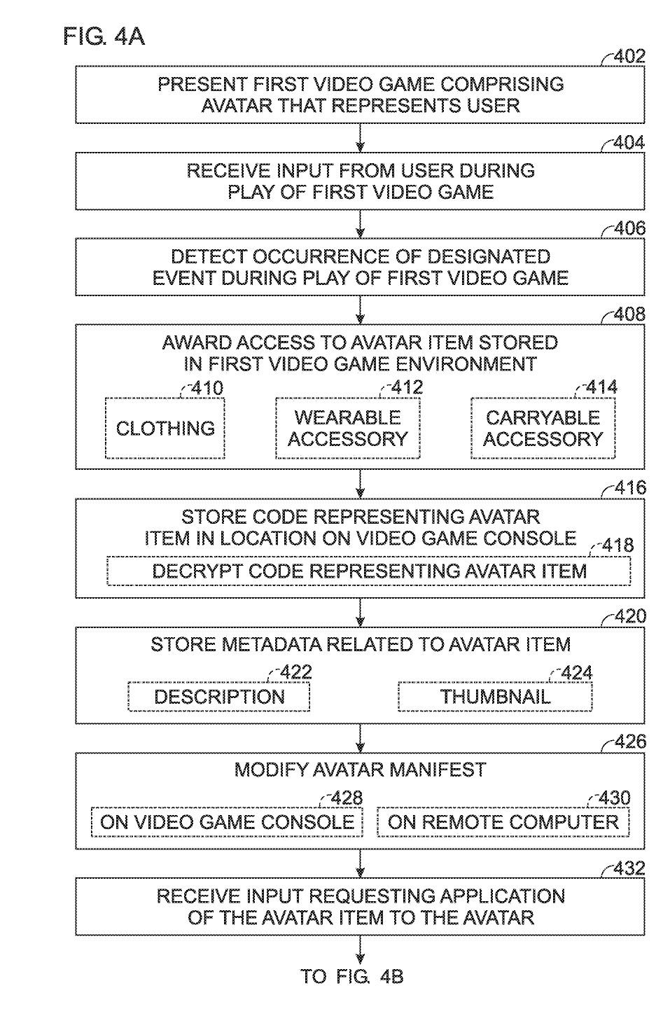

FIG. 4 shows another embodiment of a more detailed method 400 of introducing a new avatar item into avatar system 200. Similar to method 300, method 400 first comprises, at 402, presenting a first video game to a user, wherein the first video game includes an avatar that represents the user. The first video game may be presented via an optically readable disk or flash cartridge on a video game console, via a network server, or via any other suitable medium. Method 400 then comprises, at 404, receiving input from a user during play of the first video game, and, at 406, detecting an occurrence of a designated event during play of the first video game. Upon detecting the occurrence of the designated event, method 400 comprises, at 408, awarding access to an avatar item stored in the first video game environment to the user.

Any suitable avatar item may be awarded to the user. FIG. 4 shows three non-limiting examples as clothing 410, wearable accessories 412, and carryable accessories 414. Clothing 410 may include such items as shirts, pants, shoes, suits, vests, outfits, etc. Wearable accessories 412 may include such items as rings, other jewelry, wristbands, glasses, hats, etc. Carryable accessories 414 may include items such as purses, guitars or other musical instruments, animated items such as small dogs, cats, and/or any other suitable item that can be carried by an avatar.

Upon awarding the user access to the avatar item, method 400 next includes, at 416, storing code representing the avatar item in a location on the video game console. Further, if the code representing the avatar item is encrypted, the avatar item may be decrypted, as indicated at 418, when stored, when applied to the user's avatar, or at any other suitable time. Code representing an appearance of an avatar item may be encrypted, for example, when the avatar item is sent to the user over a network link. This may help prevent “man in the middle” attacks on the video game console in which a copy of the avatar item is intercepted during network transport and then modified with malicious code. Likewise, an avatar item may be encrypted with a key owned by a video game console manufacturer to help control the creation and distribution of avatar items, and therefore to help maintain the value of avatar items.

In addition to storing the avatar item on the video game console, method 400 may further comprise, at 420, storing metadata related to the avatar item on the video game console. In some embodiments, an avatar item may comprise metadata in addition to the code representing the appearance of the avatar item. Such metadata may include, but is not limited to, a description 422 of the avatar item and a thumbnail image 424 of the avatar item. The description 422 and thumbnail image 424 of the avatar item may be displayed, for example, when a user requests information related to the avatar item, and allow such a user to obtain information on the avatar item without actually applying the avatar item to the user's avatar. The description 422 may include any suitable information related to the avatar, including but not limited to text showing an avatar item name, a description of the appearance of the avatar item, a description of an achievement that the user met to acquire access to the avatar item, etc. Likewise, the thumbnail image 524 may show any suitable visual representation of the avatar item.

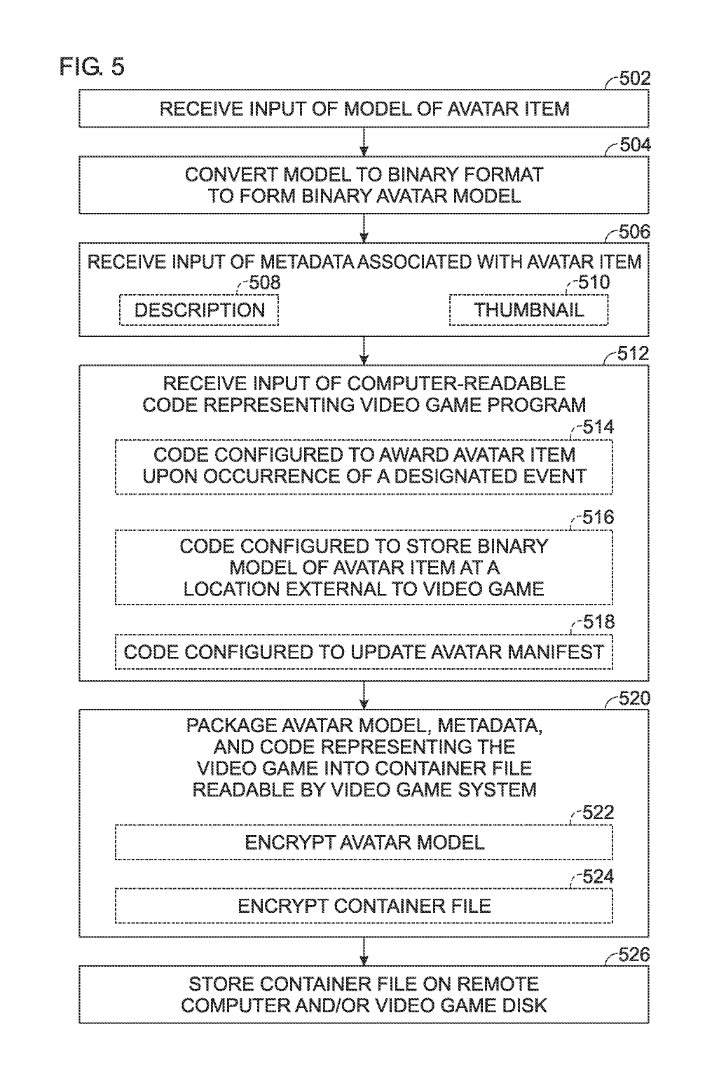

Continuing with FIG. 5, after awarding the user access to the avatar item, method 400 may further include, at 426, modifying a user's avatar item list and/or avatar manifest in the manner described above to show that access to the avatar item has been obtained. The avatar item list and/or avatar manifest may be modified on the video game console, as indicated at 428, on a remote computer (such as a game server), as indicated at 430, and/or at any other suitable location where these data structures are stored.

Upon being awarded access to the avatar item, the first video game may present the user the option of applying the avatar item to the user's avatar. Alternatively, the user may open a closet application, as described above, at a later time to apply the avatar item to the user's avatar. In either case, method 400 next comprises, at 432, receiving an input requesting the application of the avatar item to the user's avatar, and then, at 5434, displaying the user's avatar with the avatar item. This may occur during play of the first video game, during play of another video game after ceasing play of the first video game, between video games, or at any other suitable time.

Next, at 436, method 400 comprises receiving a request from the user to play a later interactive entertainment activity. The later interactive entertainment activity may be a second video game, an application, chat session, forum, community, and instant messaging service, or any other activity in which the user's avatar is displayed. Then, method 400 comprises, at 438, presenting the later interactive entertainment activity to the user, and, at 440, displaying the avatar with the avatar item in the later interactive entertainment activity. Because the avatar item and manifest are stored outside of the first video game environment, the avatar item is available for display in other video games. Further, when the avatar item is stored on a networked computing device, other players of a multi-player game, other chat participants, etc. may also view the avatar item by accessing the item on the network server. It will be noted that the other users will not be able to wear the item themselves unless they obtain or have obtained access to the avatar item themselves via game play.

A video game console manufacturer may allow outside companies to develop games for use with its console. Such a company may wish to allow outside developers to utilize avatar item awards in games developed for its console. However, such a company also may want to protect the value of such avatar items via controls in the game development and approval process. Therefore, FIG. 5 shows an embodiment of a method 500 of incorporating avatar item awards in a video game during a game development and publishing process that may help to preserve avatar item value and quality.

Method 500 first comprises, at 502, receiving an input of a three dimensional (3-D) model of an avatar item for conversion into a format readable by the video game console, such as a binary format. The 3-D model may be prepared, for example, via proprietary or commercially available 3-D graphics creation software. In some embodiments, samples and templates may be made available for use by the 3-D graphics creation software to aid in avatar item creation. After creation, the model further may be exported into a designated file format for conversion into the format readable by the video game console. For example, in one specific embodiment, the 3-D model of the avatar item may be exported from the graphics creation software into an FBX file, which is an open file format developed by Autodesk of San Rafael, Calif. In other embodiments, any other suitable file format may be used.

Next, method 500 comprises, at 504, converting the model of the avatar item to a binary avatar model. As different 3-D graphics software programs may convert files to FBX (or other) format in slightly different ways, the conversion performed at 504 may be done with different conversion modules corresponding to different software used to create the original 3-D avatar item model.

Method 500 next comprises, at 506, receiving an input of metadata associated with the avatar item. Such metadata may include, but is not limited to, a description 508 of the avatar item, and a thumbnail image 510. Method 500 also comprises, at 512, receiving an input of computer-readable code that represents the video game program and that is executable to present the video game to a user. Such code may include, but is not limited to, code 514 configured to award the avatar item to a user upon occurrence of a designated event in the video game; code 516 configured to store the model of the avatar item at a location external to the video game when the avatar item is awarded to a user; and code 518 configured to update a user's avatar item list, avatar manifest, or other such data structure upon award of the avatar item.

Next, at 520, the binary avatar model, the metadata, and the code representing the video game are packaged into a container file readable by the video game console. The binary avatar model may be encrypted, as indicated at 522 and described above, to prevent the inclusion of malicious code via a “man in the middle” attack that occurs during transmission of the binary avatar model over an unsecure network. Further, the container file may be encrypted, as indicated at 524, to help prevent the inclusion of unauthorized modifications, malicious code, etc. into the video game code. Process 520 also may include a human review step to ensure that the submitted materials meet policy and quality standards. Finally, as indicated at 526, the container file may be stored on a remote computer, such as a game server, and also may be stored and distributed on video game disks and/or cartridges for sale to consumers.

It will be understood that the configurations and/or approaches described herein for introducing new avatar items into an avatar system are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and subcombinations of the various processes, systems and configurations, and other features, functions, acts, and/or properties disclosed herein, as well as any and all equivalents thereof.

1. A computer-readable medium comprising code stored thereon that is executable by a processor on a computing device to perform a method of presenting a video game to a user, the code comprising:
code executable to display in the video game an avatar representing the user;
code executable to receive input from a user of the video game during game play;
code executable to detect an occurrence of a designated event in the video game during game play that results from input received from the user during game play;
code executable to award the user access to an avatar item upon the occurrence of the designated event; and
code executable to store code representing the appearance of the avatar item in a location external to the video game.

2. The computer-readable medium of claim 1, wherein the code representing the appearance of the avatar item comprises code representing one or more of a clothing item, a wearable accessory item, and a carryable accessory item.

3. The computer-readable medium of claim 1, wherein the computer readable medium comprises an optically readable disk or flash cartridge.

4. The computer-readable medium of claim 1, wherein the computer-readable medium comprises a storage medium on a remote computer accessible over a network link.

5. The computer-readable medium of claim 1, wherein the code representing the appearance of the avatar item is encrypted.

6. The computer-readable medium of claim 1, further comprising code representing metadata related to the avatar item.

7. The computer-readable medium of claim 6, wherein the designated event comprises one or more of reaching a designated score in the video game, completing the video game, and completing a level in the video game.

8. The computer-readable medium of claim 1, wherein the location external to the video game comprises a location on a video game console.

9. The computer-readable medium of claim 1, further comprising code executable to update a data structure stored in a location external to the video game upon being awarded access to the avatar item, wherein the data structure is updated with information related to possession of the avatar item.

10. A method of operating a video game console, the method comprising:
presenting a first video game to a user via the video game console, the first video game comprising an avatar that represents the user;
receiving input from the user during game play of the first video game;
detecting an occurrence of a designated event during play of first video game that results from input received from the user;
in response, awarding access to an avatar item stored in the first video game environment, storing code representing the avatar item at a location on the video game console, and modifying a data structure stored on the video game console to indicate that the avatar item is possessed;
receiving an input requesting application of the avatar item to the avatar;
displaying the avatar with the avatar item in the first video game;
receiving a request from the user to play a later interactive entertainment activity;
presenting the later interactive entertainment activity to the user; and
displaying the avatar with the avatar item in the later interactive entertainment activity.

11. The method of claim 10, further comprising, after receiving the input requesting application of the avatar item to the avatar, modifying an avatar manifest stored on the video game console to indicate that avatar item is currently applied to avatar.

12. The method of claim 10, further comprising synchronizing the data structure with a copy of the data structure stored on the network server.

13. The method of claim 10, wherein presenting the first video game comprises presenting the first video game via an optically readable disk or flash cartridge inserted in the video game console.

14. The method of claim 10, wherein presenting the first video game comprises presenting the first video game via a network server.

15. The method of claim 10, further comprising decrypting the avatar item.

16. The method of claim 10, wherein the later interactive entertainment activity comprises one or more of a second video game, an application, a chat session, a forum, a community, and an instant messaging service.

17. The method of claim 10, wherein the avatar item comprises one or more of a clothing item, a wearable accessory item, and a carryable accessory item.

18. A method for incorporating an avatar item award into a video game program, the method comprising:
receiving an input of a model of the avatar item for conversion to a binary format;
converting the model of the avatar item to the binary format to form a binary model of the avatar item;
receiving an input of one or more items of metadata associated with the avatar item;
receiving an input of computer-readable code representing the video game program, the computer-readable code comprising code configured to award the avatar item to a video game player upon an occurrence of a designated event when playing the video game, code configured to store the binary model of the avatar item at a location external to the video game upon award of the avatar item, and code configured to update a data structure located external to the video game upon award of the avatar item to the video game player; and
packaging the binary model of the avatar item, the one or more items of metadata, and the computer-readable code representing the video game into a container file readable by a video game system.

19. The method of claim 18, further comprising securing the binary model of the avatar item by encrypting with a key.

20. The method of claim 18, wherein the one or more items of metadata include one or more of an avatar description and a thumbnail image of the avatar.
